(19) United States
(12) Patent Application Publication
(10) Pub. No.: US 2018/0039921 A1
(43) Pub. Date: Feb. 8, 2018

(54) GENERATING DOMAIN-SPECIFIC PROCESS STUDIOS

(71) Applicant: Xerox Corporation, Norwalk, CT (US)

(72) Inventor: Adrian Corneliu Mos, Meylan (FR)

(73) Assignee: Xerox Corporation, Norwalk, CT (US)

(21) Appl. No.: 15/228,493

(22) Filed: Aug. 4, 2016

(51) Int. Cl. G06Q 10/06; G06F 3/0484

(52) U.S. Cl. CPC G06Q 10/067; G06F 3/04845

(57) ABSTRACT

A method of generating a domain-specific graphical process studio is provided. The method includes performing initialization and/or an update of a generated domain-specific process studio (GDPS); combining a domain specification and a GDPS template; displaying a freshly generated GDPS instance; providing a way for a user to select a domain to work in via a user interface; receiving data from the user regarding new diagrams that have been created or existing saved diagrams that have been selected from one or more centralized repositories; receiving data regarding collaboratively edited diagrams from one or more users; and/or receiving updates from monitoring infrastructure populating the process diagram and the various version numbers being shown in the diagrams received.

### BACKGROUND

The exemplary embodiment relates to business process design and finds particular application in connection with a system and method for generating complex integrated development environments for domain-specific business processes (or studios).

Business Process Management (BPM) and Service Oriented Architectures (SOA) are two significant aspects of business enterprise solutions. BPM addresses the methodology and tools that enable the management of business processes (BPs) as they evolve throughout their lifecycles. A Business Process Management Suite (BPMS) executes business processes and connects them to various enterprise resources, such as a personnel directory, various legacy applications, and, in some cases, to the organization's SOA. An enterprise SOA typically manages the reusable technical services used to execute tasks that occur in business processes. Their functionality, granularity, and interfaces define their level of reuse across a multitude of business processes. In general, the closer the SOA services match the business requirements, the faster it is to implement new business processes.

The area of business process design is an important activity of BPM, which is supported in various ways by the BPMS. Process design is important because it enables the expression of the inner workings of business processes to render them executable. This complements and improves the classical business application development practices where requirements are typically passed on to developers that actually create the application. Business processes (BPs) are often modeled in abstract terms by business-oriented users who have a good business knowledge and understanding of the various roles in the organization, but who are not necessarily familiar with the details of the Information Technology (IT) services that will ultimately be used to implement the processes in the SOA. Using BPM, business analysts can design, manage and control business processes themselves, up to the execution and analysis of the results. Business-oriented users typically use a language such as Business Process Model and Notation (BPMN) to describe a business process. This language contains elements such as “activity,” “gateway,” “signal,” and “flow”. Users often describe their BPs by assigning textual labels such as “payment” or “customer registration” to the generic BPMN elements. Once the business process descriptions are created, a BPMN editor enables users to assign roles from the organization's hierarchy to human activities, to generate forms for manual tasks, to write business rules in scripting languages to condition various execution flows as well as to connect certain tasks to SOA services, among other features. The business analysts may create the process designs graphically using BPMN with the goal of eventually executing the processes on an appropriate infrastructure supported by the BPMS.

It can be said that BPMN is for business processes what UML is for software applications. It is a generic language, which has flowchart-like metaphors and a number of other elements that are useful for business process design. Its generality makes it inherently business domain-agnostic, just like UML is domain-agnostic. It is meant to be used for any business process in any domain (e.g., healthcare, transportation, finance, etc.). This poses various major problems. In particular, concerning process design limitations, the BPMN standard lacks guidance to reach executable processes from high-level process models. A level-based top-down approach to design business processes (descriptive level, analytic level and execution level) has been proposed. However, the generality of the most common BPMN 2.0 graphical elements, in particular the Task element, lacks semantic expressiveness. Business analysts require dedicated means (e.g., specific type of task with implicit domain knowledge) to effectively model their business domain.

Domain-specific process modeling languages (DSPML), a sub-family of domain-specific languages (DSL) can have significant advantages over BPMN. The use of DSLs is an effective way to deal with application domains in software development, providing improvements in expressiveness and usability. DSPMLs specifically refer to process modelling languages, where business stakeholders can design their processes in a much more intuitive way than BPMN. Using a graphical or textual language specifically designed for their domain (e.g., a healthcare language), business analysts can focus on their areas of expertise, removed from the technicalities of BPMN. In addition, the DSPML has well defined concepts that can be evolved over time (and versioned). The advantages that this brings include better governance, fast process evolution, multi-target deployment, and non-ambiguous monitoring. It is important to understand, however, that using DSPMLs does not mean replacing the entire BPM infrastructure. On the contrary, such infrastructure, including its BPMN support, would be reused. DSPML environments are essentially an additional layer over the typical BPM stack. A process designed in DSPML would be converted to BPMN and would eventually execute in the BPMS. Further transformations may be performed, however, at various stages, for instance for monitoring reasons.

While it is clear that using DSPML can bring important advantages in the BPM space, the cost of such an approach can be a significant hurdle. Organizations that adopt the approach must make sure that they have tool support and in particular process studios that support all the domains in which they do business. These studios need to be kept up to date constantly so that the processes being designed correspond to the latest corporate know-how for the business domains. BPMN does not evolve very often. In contrast, a DSPML could change constantly, and its ability to evolve, and bring wide-ranging instant process change across the large collections of processes it supports, is one key advantage. So a major problem is dealing with the development and maintenance of such studios. Creating and maintaining them together with all the connections they have to other components from the existing BPM infrastructure, such as BPMN editors, execution layers and monitoring, could be very costly.

Process studios are essential tools for organizations in order to implement the BPM methodology and capture the business knowledge in process designs. There is currently an overall increasing interest in studios (or workbenches) supporting domain specific languages (DSLs).

Process design solutions in the industry focus today on BPMN and, therefore, they are generic with respect to the business domains. Current tools, however, lack a domain governance aspect provided by a domain specific layer. While these tools allow the design of business processes using a standard notation, they do not provide a process studio that is tailored to the business knowledge of the user's organization. For instance, the editor and the palettes do not get updated to reflect evolutions in the organization's domain concepts. Indeed, the solutions are essentially static, as they do not evolve with the specific needs of both the modeler and the organization.

Current process discovery tools are not fully featured BPM design tools, as they focus on the extraction of shared knowledge from a group of business experts. The experts collaboratively and iteratively make a simple process design emerge using simple box and arrow graphical descriptions with free-form text in them (i.e., comparable to DSLs). However, such tools do not target executable processes, and they do not use non-ambiguous concept definitions as atomic elements in the designs. They are merely collaborative graphical flow diagram editors with social elements, connected in a shared enterprise document repository.

Some have proposed relying on Eclipse-tooling to automatically create domain specific visual language editors but not specific to BPM. However, this would not integrate process specific needs, such as the integration with a monitoring layer, or the BPMN generation, which are essential for business process experts. These process specific features are challenging and technically difficult to integrate. In order to simplify process design and model specific needs, BPMN extensions have been proposed to deal, for instance, with quality or security issues. These approaches are limited by their focus in a very concrete problem space while still having to deal with the complexity and generality of BPMN. Goal-oriented approaches use goal models as a preliminary step for process modelling. However, the graphical notations of the more popular goal oriented languages (i*, KAOS and MAP) still lack Semantic Transparency. The lack of tool support and the generality of their graphical notations imply that business stakeholders may find similar difficulties in building goal-models as with standard generic business process models.

Therefore, there is a need for a method and system for generating intuitive, yet feature-rich, graphical process studios for various business domains that are fully integrated with standard business process management solutions.

### INCORPORATION BY REFERENCE

The following references, the disclosures of which are incorporated herein by reference, are mentioned:

U.S. Pub. No. 20130232464, published Sep. 5, 2012, entitled DEPLOYMENT OF BUSINESS PROCESSES IN SERVICE-ORIENTED ARCHITECTURE ENVIRONMENTS, by Jacquin, et al., discloses methods of deploying business processes in different SOAs automatically.

U.S. Pub. No. 20150046212, published Feb. 12, 2015, entitled MONITORING OF BUSINESS PROCESSES AND SERVICES USING CONCEPT PROBES AND BUSINESS PROCESS PROBES, by Adrian C. Mos discloses a system and method for monitoring business processes including business activities and, in particular, to business processes running in a Business Process Management Suite (BPMS) which calls services running in a Service Oriented Architecture (SOA).

U.S. application Ser. No. 14/560,293, filed on Dec. 4, 2014, entitled HUMAN TASK MONITORING AND CONTEXTUAL ANALYSIS FOR DOMAIN SPECIFIC BUSINESS PROCESSES, by Kunal Suri, et al.

U.S. application Ser. No. 14/691,261, filed on Apr. 20, 2015, entitled PRESERVING CONSISTENCY IN DOMAIN-SPECIFIC BUSINESS PROCESSES THROUGH SEMANTIC REPRESENTATION OF ARTIFACTS, by Adrian Corneliu Mos, et al., describes a method for semantic representation of artifacts.

### BRIEF DESCRIPTION

In accordance with one aspect of the exemplary embodiment, a method of generating a domain-specific graphical process studio is provided. The method includes performing initialization and/or an update of a generated domain-specific process studio (GDPS); combining a domain specification and a GDPS template; displaying a freshly generated GDPS instance; providing a way for a user to select a domain to work in via a user interface; receiving data from the user regarding new diagrams that have been created and/or automatically loading existing saved diagrams that have been selected from one or more centralized repositories; receiving data regarding collaboratively edited diagrams from one or more users; and/or receiving updates from monitoring infrastructure populating the process diagram and the various version numbers and other details being shown in the diagrams received.

In accordance with another aspect of the exemplary embodiment, a system for generating a domain-specific graphical process studio is provided. The system comprising memory and at least one processor, wherein the system is configured to: perform initialization and/or an update of a generated domain-specific process studio (GDPS); combine a domain specification and a GDPS template; display a freshly generated GDPS instance; provide a way for a user to select a domain to work in via a user interface; receive data from the user regarding new diagrams that have been created and/or automatically load existing saved diagrams that have been selected from one or more centralized repositories; receive data regarding collaboratively edited diagrams from one or more users; and/or receive updates from monitoring infrastructure populating the process diagram and the various version numbers and other details being shown in the diagrams received.

In accordance with yet another aspect of the exemplary embodiment, a non-transitory computer-usable data carrier storing instructions that, when executed by a computer, cause the computer to perform a method of generating domain-specific graphical process studios is provided. The method includes performing initialization and/or an update of a generated domain-specific process studio (GDPS); combining a domain specification and a GDPS template; displaying a freshly generated GDPS instance; providing a way for a user to select a domain to work in via a user interface; receiving data from the user regarding new diagrams that have been created and/or automatically loading existing saved diagrams that have been selected from one or more centralized repositories; receiving data regarding collaboratively edited diagrams from one or more users; and/or receiving updates from monitoring infrastructure populating the process diagram and the various version numbers and other details being shown in the diagrams received.

Optionally, and in accordance with any of the previous embodiments, the domain specification may comprise a domain meta-model and domain descriptions, the domain meta-model comprising domain information for an enterprise with regard to the specification of concepts that are going to be reused in business processes and the domain descriptions comprising knowledge of a business domain configured for reuse and combining business concepts in business processes.

Optionally, and in accordance with any of the previous embodiments, the domain meta-model is configured to: describe a data structure of arbitrary domain specifications, store domain information for each business domain in a central repository on a collaboration and distribution server, generate a domain editor that can be used standalone or embedded in a graphical editor as part of a diagram designer used in the GDPS, provide model matching when combining generic process elements with domain elements and/or specify and update Service Level Agreements for business concepts.

Optionally, and in accordance with any of the previous embodiments, the GDPS template may comprises a diagram editor template and a palette template, the diagram editor template comprising a declarative model-based description of one or more capabilities that the GDPS offers to provide graphical process modelling and configured to match graphical elements to the domain meta-model and to a generic process representation and the palette template comprising the main functionality of a process design tool palette.

Optionally, and in accordance with any of the previous embodiments, the palette template is updated each time a GDPS instance is launched.

Optionally, and in accordance with any of the previous embodiments, the GDPS template may further comprise one or more business process model and notation (BPMN) templates configured for BPMN generation and one or more common base templates.

### BRIEF DESCRIPTION OF THE DRAWINGS

FIG. 1 is a functional block diagram of a computer-implemented system for generating domain-specific process studios in accordance with an aspect of the exemplary embodiment;

FIG. 2 is an illustration of a domain meta-model in accordance with an aspect of the exemplary embodiment;

FIG. 3 shows a simplified domain description instance in accordance with an aspect of the exemplary embodiment;

FIG. 4 is a flowchart illustrating a method of generating domain-specific process studios in accordance with an aspect of the exemplary embodiment;

FIG. 5 illustrates a generated domain-specific process studio instance in accordance with an aspect of the exemplary embodiment;

FIG. 6 illustrates a process of matching domain-specific and generic process concepts to diagram elements in accordance with an aspect of the exemplary embodiment;

FIG. 7 shows a concept with editor overly in accordance with an aspect of the exemplary embodiment;

FIG. 8 shows possible palette representations generated from similar templates in accordance with an aspect of the exemplary embodiment; and

FIG. 9 is a screenshot of a generated domain-specific process studio instance in accordance with an aspect of the exemplary embodiment; and

FIG. 10 illustrates two screenshots representing collaborative editing in accordance with an aspect of the exemplary embodiment.

### DETAILED DESCRIPTION

The exemplary embodiment reduces the need for costly development and maintenance of such studios while ensuring that business users have consistent access to the ever-evolving enterprise body of knowledge. The exemplary embodiment uses model-based transformations to generate and support the entire infrastructure required by the studios. This includes a graphical user interface, conversion capabilities to and from BPMN, embedding of real-time monitoring data from business process engines and service oriented platforms, live multi-user collaboration support, process governance and evolution, domain know-how management, along with service-level agreement monitoring.

The generated domain-specific process studio (GDPS) approach described below uses live collaboration on diagrams that contain domain-specific process elements directly connected to the shared domain description. The resulting process designs can be developed, deployed, and executed as the processes contain the required technical connections through the concept definitions that underline the composing elements.

As used herein, the term “business process” refers to a systematic aggregation of various activities comprising of either manual activities, automated activities, or a combination of both manual and automated activities, all of which provide certain value to its end customer.

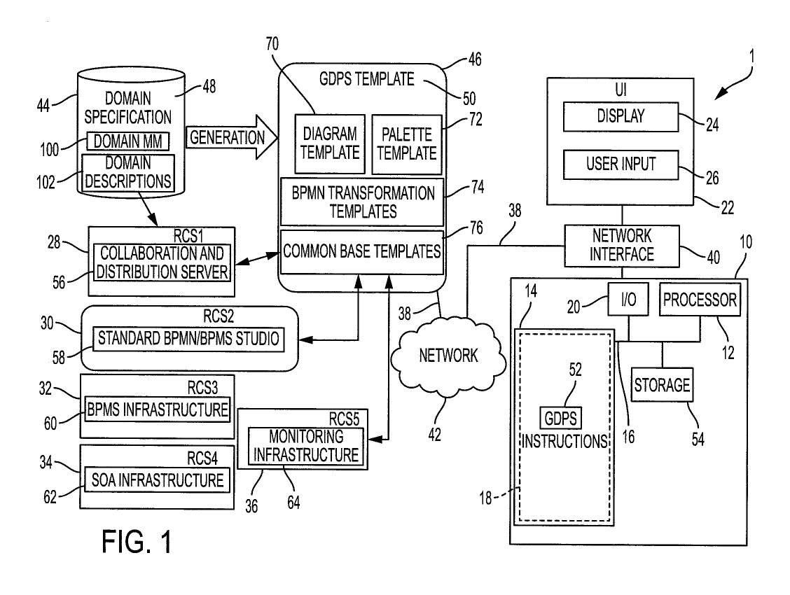

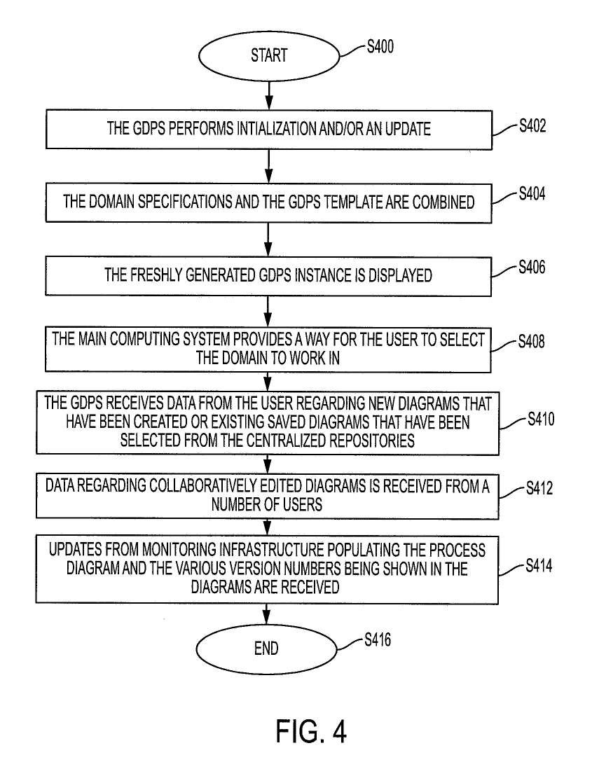

FIG. 1 is a functional block diagram of a computer-implemented system 1 suitable for generating domain-specific process studios as disclosed herein. As will be appreciated, separate computer systems may be configured and connected for monitoring and for running individual services, activities, and processes. The illustrated system 1 includes a main computing device 10, including a processor 12, which controls the overall operation of the computing device 10 by execution of processing instructions, which are stored in a system memory 14 connected to the processor 12 by a bus 16. The processor 12 also executes instructions 18, stored in the memory 14, for performing the exemplary method outlined in FIG. 4, among other things.

The system 1 may include multiple processors 12, wherein each processor is allocated to processing particular (or sets of) instructions. The system 1 also includes one or more interfaces to connect the main computing device 10 to external devices, including an input output (I/O) interface 20. The I/O interface 20 may communicate with a user interface 22. The user interface 22 may include one or more of a display device 24 for displaying information to users, such as an LCD screen or the like, and a user input device 26, such as a keyboard, a touch or writable screen, and/or a cursor control device, such as a mouse, trackball, or the like, for inputting instructions and communicating user input information and command selections to the processor 12. The I/O interface 20 also links the computing device 10 with external devices, such as the illustrated remote computing systems 28, 30, 32, 34, and 36 via wired and/or wireless links 38. For example, the I/O interface 20 may include, or communicate with, a network interface card (NIC) 40, which is in turn connected to a computer network 42, which links the main computing device 10 to the remote computing systems 28, 30, 32, 34, and 36, as well as the illustrated central repositories (or databases) 44 and 46, which store domain specifications 48 and Generated Specific Process Studio (GDPS) templates 50, respectively. The central repositories 44 and 46 may be separate (as shown) or combined and each may represent any type of non-transitory computer readable medium, such as random access memory (RAM), read only memory (ROM), magnetic disk or tape, optical disk, flash memory, holographic memory, or the like.

The memory 14 may store instructions 18 for executing various software components, such as a generated domain-specific process studio (GDPS) 52. These components may in turn be composed of other components, explained further below. The system 1 may also include a storage unit 54, which may be removable or fixed. The storage unit 54 may store, for example, data sufficient to load into memory the domain specifications 48 and the GDPS templates 50 for a GDPS instance.

The main computing device 10 may include a PC, such as a desktop, a laptop, palmtop computer, portable digital assistant (PDA), server computer, cellular telephone, pager, or other computing device or devices capable of executing instructions for performing the exemplary method or methods described herein.

The memory 14 and the storage unit 54 may be separate or combined and each may represent any type of non-transitory computer readable medium, such as random access memory (RAM), read only memory (ROM), magnetic disk or tape, optical disk, flash memory, or holographic memory. In one embodiment, the memory 14 and the storage unit 54 comprise a combination of random access memory and read only memory. In some embodiments, the processor 12, the memory 14, and/or the storage unit 54 may be combined in a single chip.

The I/O interface 18 communicates with other devices via the computer network 42, such as a local area network (LAN), a wide area network (WAN), or the internet, and may comprise a modulator/demodulator (MODEM), among other things. The digital processor 12 can be variously embodied, such as by a single core processor, a dual core processor (or more generally by a multiple core processor), a digital processor and cooperating math coprocessor, a digital controller, or the like.

With reference to FIG. 1, the remote computing systems 28, 30, 32, 34, and 36, which may be separate or combined, may be similarly configured to the main computing device 10, i.e., they may include memory and a processor.

One or more of the remote computing systems (e.g., RCS 1) 28, may provide access to a collaboration and distribution server 56, which aids model distribution across various remote instances of the studio, as well as the constant updating of the shared business domain model. A collaboration part (not shown) handles simultaneous changes to process models being managed by various stakeholders. Accordingly, such changes are transmitted live to all the diagrams that happen to be open and that refer to the process elements being changed. Note that several diagrams can refer to the same process model. This is because a diagram can contain several processes of which some are shared with other diagrams. It can also happen that different points of view of the same process (with more or less details for instance) need to be made available to stakeholders of different roles due to various security clearance levels or indeed several levels of domain expertise. The synchronization is done in a way that is similar to that in which concurrent version control systems work, with intuitive visual support. Locks are automatically visually added to process elements that are being changed in another diagram until the user having initiating the change does not release them. Locks can be added to a whole process or to a process element (for instance a user is in the process of changing the SLA of a domain concept used in a process activity). In addition, locks can be added automatically to process fragments (for instance if a transition is removed, the source and destination activities of the transition would be locked in all diagrams). A distribution part (not shown) of the server pertains to the sharing of the most recent version of the domain description across all instances of the GDPS. One can imagine that a large company could have at any given moment hundreds of users operating GDPS instances, for each industry vertical in which the company operates. As the domain knowledge evolves, the system 1 ensures that all the instances share the latest version of the domain specification(s).

Another one of the remote computing systems (e.g., RCS 2) 30 may provide access to a standard BPMN/BPMS studio 58, which implements a business process description by running a business process. The BPMS 58 may include an execution engine (not shown) for executing Business Process Execution Language (BPEL) scripts, or another type of runtime engine. Another of the remote computing systems (e.g., RCS 3) 32 may provide access to a BPMS infrastructure 60.

Another one of the remote computing systems (e.g., RCS 4) 34 may provide access to a Service Oriented Architecture 62, providing the BPMS processes with access to services that execute the business process. The BPMS studio 58, the BPMS infrastructure 60, and the SOA 62 are described, for example, in co-pending and commonly assigned U.S. Publication No. 2015/0046212, entitled “MONITORING OF BUSINESS PROCESSES AND SERVICES USING CONCEPT PROBES AND BUSINESS PROCESS PROBES,” filed Aug. 9, 2013, by Adrian C. Mos, the content of which is totally incorporated herein by reference. A detailed description of these remote computing systems is provided in the '212 publication.

Yet another one of the remote computing systems (RCS 5) 36, may provide access to a monitoring infrastructure 64, which generally includes a human task monitoring and contextual analysis (“HTMCA”) component (not shown).

The BPMS 58 includes a BPMS monitoring component (not shown), which monitors automated activities. The SOA 62 includes an SOA monitoring component (not shown), which monitors one or more services. The BPMS monitoring component and SOA monitoring component provide automated monitoring data to a business process probe (not shown) and concept probes (not shown) via the network 42. The HTMCA component typically includes a HTMCA monitoring component (not shown), which monitors manual activities, among other things.

The monitoring infrastructure 64 provides a further monitoring layer on top of the automated BPMS and SOA monitoring components that includes a set of concept probes. Rather than relying on generic mechanisms to provide monitoring data, the monitoring layer uses the concept probes to provide monitoring information. The concept probes match the business concepts used in the definition of the business activities which form the business processes. The concept probes combine monitoring information (i.e., automated and manual task information) from business process execution as well as service execution into aggregated information that is informative from a business concept point of view. This aggregated information may be accessed by a listener component (not shown), which in turn can be accessed by a user via a user interface, such as the user interface 22. The listener component may evaluate compliance of the monitoring information with one or more rules, such as a service level agreement (SLA) rule. In one embodiment, the listener component may communicate the rule to the business process probe and/or a concept probe. The listener component registers the SLA rule with the probe and receives/outputs an alert if the SLA rule is violated.

This monitoring approach provides several advantages. First, it provides a much better understanding of the various execution parameters of the business concepts used in processes (including performance, correctness, and context). Second, it helps with setting application-wide alarms and constraints potentially corresponding to Service-Level-Agreements, on a concept-level. For a given concept, such constraints can be set-up with immediate effect in all the business processes that use the concept. Third, this approach gives technical users a deep understanding of the contribution of each of multiple application layers (BPMS, SOA, HTMCA, etc.) to the combined performance of a particular business concept, which can lead to rapid deployment of modifications to particular services, changes in business partners (that provide better services) or improvements in the underlying infrastructure or application parameters.

The concept probes may be configured to interface with the BPMS monitoring component for automated task data collection. Similarly, for manual task data collection, the concept probes can connect to the HTMCA. Likewise, for SOA data collection, the concept probes can connect to the SOA monitoring layer using, for example, a specific Enterprise Service Bus to collect metrics of interest.

The Generated Domain-Specific Process Studio (GDPS) 52 corresponds to a design, governance and collaboration layer on top of existing BPM technology infrastructure. The source of truth for the process artifacts (all the files representing serialized diagrams of any kind) is the domain-specific process model repository. The artifacts correspond to two types of process descriptions: a domain specific process (DSP) and BPMN processes. The process execution, however, happens in the classical BPM space, with BPMN models as the input. Such BPMN models may be enhanced (i.e., enriched and refined) in platform specific BPMN editors and they may be synchronized in a bidirectional manner with the GDPS 52. Indeed, technical architects (the most common users of BPMN) may make changes to a given process, which may impact the core of the process definition and therefore its representation as a DSP. In case of such impact, model-to-model transformations could be used to bring back the changes in the corresponding form in the DSP and render them visible in the GDPS 52. This is known as bi-directional synchronization.

Another feature of the GDPS is the connectivity to monitoring systems. A detailed implementation of domain-specific monitoring is beyond the scope of this disclosure so there is only a reference to the connection of such capabilities to the studios herein. The GDPS 52 is configured to listen to monitoring events issued by the domain-specific monitoring infrastructure and display them accordingly on the various process elements. Because of the generated nature of the GDPS 52, these connections actually happen at a meta-model-layer and are successively brought on the graphical diagrams by various model transformations. The GDPS 52 acts effectively as a monitoring client, listening to specific events and storing them in local data structures. Such structures correspond to in-memory representations of properties for meta-model instances corresponding to the business domain descriptions as well as to the process design elements (the DSPs). In addition to storing the data, the GDPS 52 registers a number of graphical event listeners to ensure that user interactions are captured and connected to the monitoring data for appropriate display. This is justified by the fact that while some monitoring information is presented directly onto the diagram elements, some detailed monitoring reports and graphs are only shown in a special view when the user selects certain process elements (the process as a whole, an individual concept in a DSP or an individual activity in a BPMN editor). With this approach, monitoring data is shown consistently irrespective of the type of diagram, and support for new types of diagrams or graphical editors can be added easily.

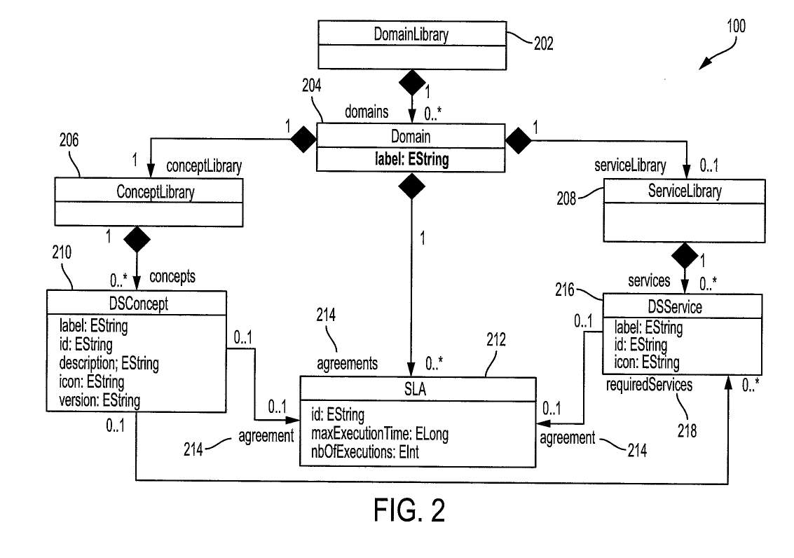

In this regard, the GDPS template 50 includes, for example, a diagram editor template 70, which is a declarative model-based description of the capabilities that the GDPS 52 offers in terms of basic graphical process modelling. It matches graphical elements to a Domain MM 100 (see FIG. 2) and to a generic process representation.

The GDPS template 50 also includes a palette template 72, which is made to contain the main functionality of a process design tool palette. It contains sections for standard functionality that is domain-independent as well as sections for domain-specific elements.

The GDPS template 50 also includes BPMN transformation templates 74. BPMN generation is part of the GDPS 52 and allows it to generate process artefacts that can be executed on state-of-the-art BPMS technology stacks. Similarly to the previous components, it has a basic implementation that corresponds to generic process descriptions. This takes as input an instance of the generic process meta-model and outputs BPMN2 representation.

Similar to BPMN generation, other standard BPM-related capabilities may be offered by the GDPS 52. These BPM-related capabilities can be used in their original form or extended through additional extension mechanisms to perform additional tasks for specific domain concepts. Some of the common base templates 76 are included here from a tooling perspective. The main capabilities required include, among other things, deployment of the domain-specific processes, SOA connectivity, domain-specific monitoring, and/or collaborative process design.

With reference now to FIGS. 1-3, the domain specifications 48 stored in the central repository 44 may be based upon the domain concepts, which comprise the explicit representations of enterprise process know-how. A generic domain meta-model as support for a domain description will be explained in greater detail. For instance, in the example of FIG. 2, a human resources domain that results in a human resource process is used. Thus, it is to be understood that other domains and business processes may be used.

The domain specifications 48 include at least two components, namely, (a) at least one domain meta-model 100 and (b) a number of domain descriptions 102. The exemplary embodiment includes the existence of domain descriptions that detail the knowledge of a business domain in a way that makes it easy to reuse and combine business concepts in business processes. The proposition of a domain specific language is out of the scope of this document as we do not aim a complete enterprise description.

The Domain Meta-Model (Domain MM) 100 pictured in FIG. 2 is defined to include most, if not all, the information that any domain description should have. The Domain MM 100 is thus a way to simply capture domain information for an enterprise, with regard to the specification of concepts that are going to be reused in business processes. The Domain MM 100 is used, for example, to describe the data structure of arbitrary domain specifications and serves various purposes, namely, (1) to store the domain information for each business domain in a central repository on the collaboration and distribution server 56, (2) to generate a domain editor (textual) that can be used standalone or embedded in a graphical editor as part of a diagram designer used in the GDPS 52, (3) to serve for model matching when combining generic process elements, such as a Process Step (provided in generic process meta-models) with domain elements (this is helpful when in a diagram the user specifies that a process step is going to perform a business function corresponding to an existing business concept), and/or (4) to specify and update Service Level Agreements for business concepts. With this enterprise-wide SLA management, most, if not all, processes that use a particular business concept would be informed about its SLA. In addition, one or more users with sufficient rights would be able to update the SLA of the concept as a whole if the evolving domain requirements demand it.

The Domain MM 100 contains, among other things, an overall Domain Library 202, which includes a number of individual business domains. In particular, each Domain 204 typically includes at least one Concept Library 206 and at least one Service Library 208. The Concept Library 206 holds the series of domain specific business concepts, e.g., DS Concept 210. In addition, they relate to SLA elements 212 that describe the various agreement 214 details. The Service Library 208 of the Domain 204 contains, for example, domain specific service elements, e.g., DS Service elements 216, which refer to the actual SOA services 218 required in the domain 204. The services 218 can be abstract entities that are bound later in the deployment process. Some elements from the Domain MM 100, notably the DS Concept 210 and the DS Service elements 216, may also contain links to icon elements, which are useful for the graphical display of diagram elements and palette entries in the GDPS 52. Specific detailed descriptions, such as the service descriptions or concept descriptions in themselves, are presented herein summarily.

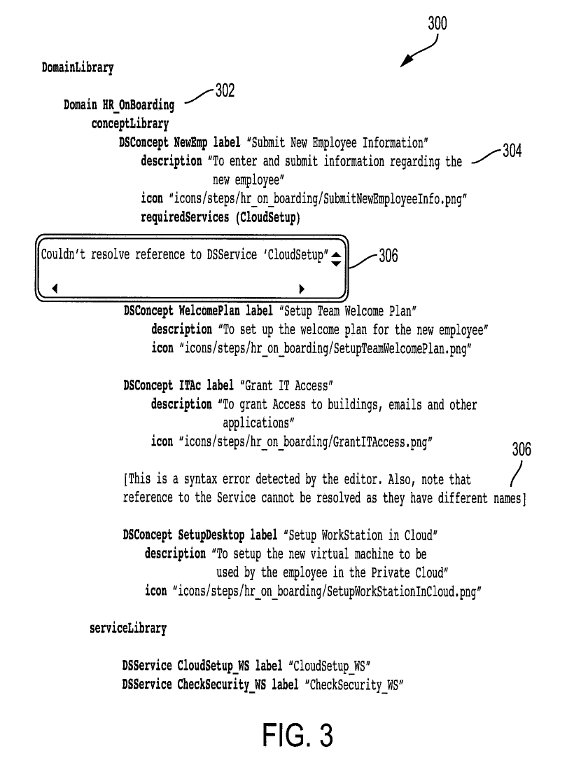

The sample text in FIG. 3 shows a simplified version of a Domain description instance 300, which, in this example, is for a human resources domain 302. It is to be understood that the domain description instances will vary for each type of domain. In FIG. 3, the text 304 is written in a generated domain editor, for example, which may have syntax highlighting, auto-completion and validation, all automatically generated from the Domain MM 100 using model-to-model frameworks. FIG. 3 depicts some sample error detections 306 caused by a bad referencing and a syntax error. Note that the version property of the domain description is optional.

The term “software” as used herein is intended to encompass any collection or set of instructions executable by a computer or other digital system so as to configure the computer or other digital system to perform the task that is the intent of the software. The term “software” as used herein is intended to encompass such instructions stored in storage medium such as RAM, a hard disk, optical disk, or so forth, and is also intended to encompass so-called “firmware” that is software stored on a ROM or so forth. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on the server or other location to perform certain functions.

As will be appreciated, FIG. 1 is a high level functional block diagram of only a portion of the components which are incorporated into a computer system 10. Since the configuration and operation of programmable computers are well known, they will not be described further.

FIG. 4 is a flowchart illustrating an exemplary method 400 of generating domain-specific graphical process studios which may be performed with the system 1 of FIG. 1. The method begins at S400.

At S402, the GDPS 52 performs initialization and/or an update by retrieving the complete repository of domain descriptions and GDPS template elements (or just the ones that have changed since the last start) from the repositories 44, 46. It is to be understood that standard distributed-system approaches would be employed (i.e., caching of previously loaded data, smart difference computation in order to only bring in changed elements, etc.) The domain specifications 48 and/or the GDPS templates 50 may be stored in the memory 54 for further processing.

At S404, the domain specifications 48, including the Domain MM 100 and the Domain Descriptions 102, and the GDPS template 50, including the diagram editor template 70, the palette template 72, the BPMN transformation templates 74, and/or the common base templates 76, are combined by filling in the blanks in the appropriate templates with the domain information.

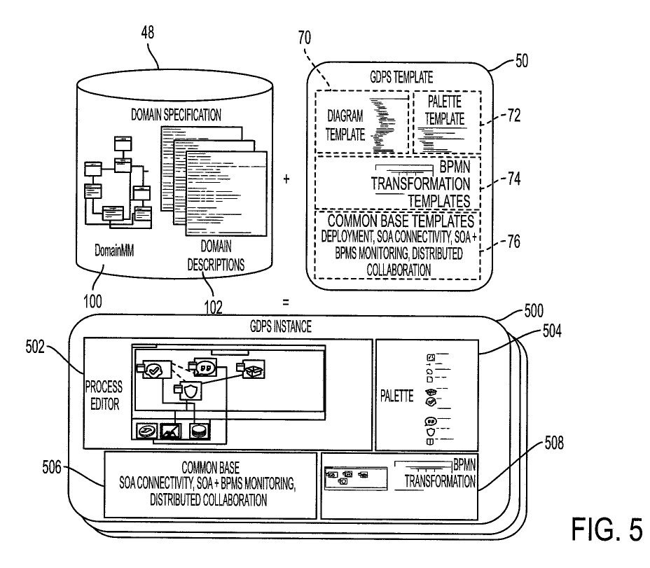

At S406, the freshly generated GDPS instance is displayed, for example, via the main computing device 10 on the display 24 of the user interface 22. See FIG. 5, which shows an example of a GDPS instance 500, featuring a diagram process editor 502, a concept palette 504, common base elements 506, and a BPMN 2 skeleton 508.

At S408, the main computing system 10 provides a way for the user to select the domain to work in, such as healthcare or finance, is offered, such as via the user interface 22. Alternatively, this could be automatically chosen based on the user profile. This could also be replaced by an option to have all domains available in the palette.

At S410, the GDPS 52 receives data from the user regarding new diagrams that have been created and/or automatically loads existing saved diagrams that have been selected from the centralized repositories 44, 46. It is to be understood, however, that there is functionality in the GDPS 52 for the user to create a new diagram and populate it with domain elements from the palette, not just “view” existing diagrams. It is further noted that the diagram is a graphical view of the process models, i.e., a way of displaying a process. As used herein, a template is pre-defined and needs to be filled in with domain specific information. Users may create processes, can load previously created processes and so on, rather than diagrams. However, diagrams could be seen as “views” over processes, because some diagrams may be richer than others in details (for the same process).

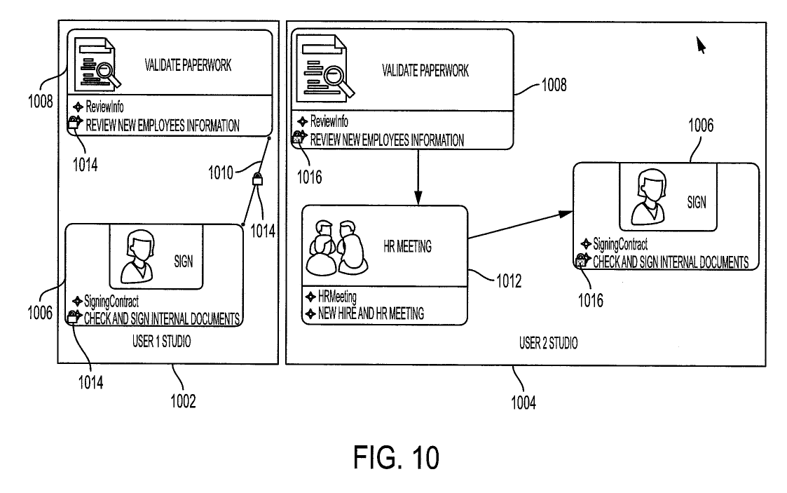

At S412, data regarding collaboratively edited diagrams is received from a number of users. Since other users may use GDPS instances all connected to the centralized repositories 44, 46, two or more users can collaborate on the same process diagram. The Collaboration and Distribution Server 56 provides, among other things, live collaboration support, including object locking and so on (see FIG. 10).

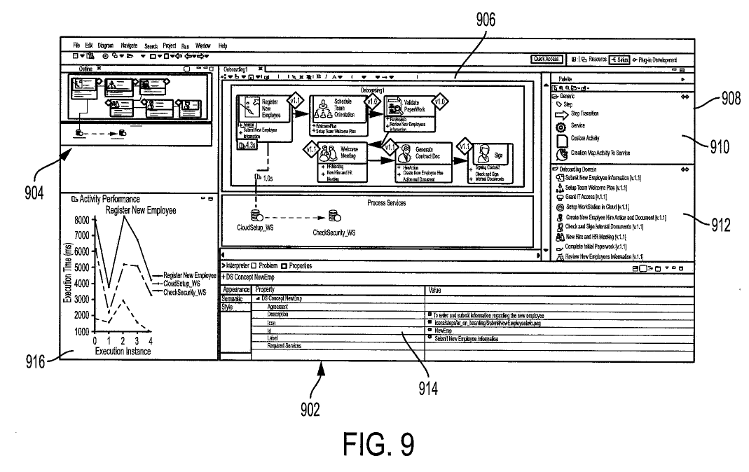

At S414, updates from monitoring infrastructure populating the process diagram and the various version numbers being shown in the diagrams are received (see FIG. 9). The method ends at S416.

Although the exemplary method 400 is illustrated and described above in the form of a series of acts or events, it will be appreciated that the various methods or processes of the present disclosure are not limited by the illustrated ordering of such acts or events. In this regard, except as specifically provided hereinafter, some acts or events may occur in different order and/or concurrently with other acts or events apart from those illustrated and described herein in accordance with the disclosure. It is further noted that not all illustrated steps may be required to implement a process or method in accordance with the present disclosure, and one or more such acts may be combined. The illustrated methods and other methods of the disclosure may be implemented in hardware, software, or combinations thereof, in order to provide the control functionality described herein, and may be employed in any system including but not limited to the above illustrated system 1, wherein the disclosure is not limited to the specific applications and embodiments illustrated and described herein.

The method illustrated in FIG. 4 may be implemented in a computer program product that may be executed on a computer. The computer program product may comprise a non-transitory computer-readable recording medium on which a control program is recorded (stored), such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other non-transitory medium from which a computer can read and use. The computer program product may be integral with the computer 30, (for example, an internal hard drive of RAM), or may be separate (for example, an external hard drive operatively connected with the computer 30), or may be separate and accessed via a digital data network such as a local area network (LAN) or the Internet (for example, as a redundant array of inexpensive of independent disks (RAID) or other network server storage that is indirectly accessed by the computer 30, via a digital network).

Alternatively, the method 400 may be implemented in transitory media, such as a transmittable carrier wave in which the control program is embodied as a data signal using transmission media, such as acoustic or light waves, such as those generated during radio wave and infrared data communications, and the like.

The exemplary method 400 may be implemented on one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphical card CPU (GPU), or PAL, or the like. In general, any device, capable of implementing a finite state machine that is in turn capable of implementing the flowchart shown in FIG. 4, can be used to implement the method. As will be appreciated, while the steps of the method may all be computer implemented, in some embodiments one or more of the steps may be at least partially performed manually. As will also be appreciated, the steps of the method need not all proceed in the order illustrated and fewer, more, or different steps may be performed.

The following sections further describe the structure and functionality of the system and method for generating complex integrated development environments for domain-specific business processes in greater detail.

The exemplary embodiment removes the need to develop and maintain such studios while enabling the use of the latest business concept versions for each domain. For instance, there could be any number of variations of, for example, a healthcare process studio or a financial services process studio, that actually reflect the business know-how of the organization active in these business domains. The approach is based on model transformations to generate the whole infrastructure that is required by the process studios. This includes the graphical interface comprising a diagram editor and a concept palette, the BPMN format and tool support, as well as enterprise system integration as part of a domain independent common-base. The latter corresponds to various functionalities that are to be accessed by the studios: 1) a displaying real-time monitoring data from the BPM and SOA runtimes, 2) live multi-user design collaboration support, 3) overall process governance and evolution, 4) concept and domain know-how editing, and/or 5) service-level agreement monitoring.

As mentioned before, the entire GDPS generation procedure is model-based. It takes input models and generates output models that are later used to instantiate executable and graphical components displayed to the user. FIG. 1 shows the various elements involved in the generation procedure. The domain specification meta-model described by the Domain MM 100 is the basis for all the representations of the business domains. For each business domain there will be a Domain Description element, which is an instance of the Domain MM 100. There will be as many GDPS instances as there are business domains. As specified earlier, the user, when starting the GDPS 52, can choose the domain, and therefore the “studio.” Since the studio may be thought of as generated on the fly based on the chosen domain, it does indeed look like there is one studio per domain. That said, this is just an example of how the approach can be used. For instance, the user could also have different icons on the screen, one for each domain in which the user designs processes. In this case, it really does look like there are several software packages, one for each domain (and there is no need for a dialog window to ask which domain to choose).

As illustrated in FIG. 5, there may be three GDPS instances 500 for the three domain descriptions 102. It is to be understood that this is just but one example, and therefore any number of GDPS instances may be started. The generation uses a GDPS two-part template 50 as the starting point. The template 50 contains a number of models and modules that correspond to functionality that is common to all GDPS instances. The basic functionality for process diagrams and for palettes is included in the form of pre-filled templates, as described above. These are domain-agnostic and can be seen as stubs containing features such as drag-and-drop and workflow diagram display and editing, which are expected to be provided for any domain. Generic process elements such as Custom Activity as well as graphical connection capabilities to display service dependencies are also provided. Beside graphical representations and user-interaction, generic business process management functionality is also provided. This includes basic BPMN generation that uses a mapping of the Domain MM to BPMN. Naturally, for the generation phase, more functionality can be added to correspond to the domain needs. For instance, for healthcare, regulatory concerns such as logging all patient interactions in electronic health records could be automatically added to certain types of activities. These could be marked in the domain description in a way that informs the generation procedure to add functionality onto of the generic BPMN transformation logic. The details of adding domain-specific BPMN generation are beyond the scope of this disclosure, which focuses on the overall generation procedure. In addition to BPMN generation, a suite of other GDPS capabilities can be provided in the GDPS template 50, related to common BPM functionalities, and which are specific to the needs of domain-specific process management (such as versioning, semantic modelling, or enterprise role mapping).

The following sub-sections describe the implementation of the two-part template for the GDPS 52 as well as the main generation mechanisms including support for BPMN and common functionalities in greater detail.

A. Diagram Editor Template

The diagram editor template 70 is a declarative model-based description of the capabilities that the GDPS 52 offers in terms of basic graphical process modelling. It matches graphical elements to the Domain MM 100 and to a generic process representation. The generic process representation meta-model needs to specify a number of basic elements describing process workflows and could be a small subset of BPMN2 or indeed a meta-model. It can be noted that this meta-model has elements that correspond to the elements in the Domain MM 100. This is because this meta-model is in fact made to create process flow descriptions. The Domain MM 100 is made to represent structure. By combining the two, dynamic process flows using domain concepts are realized.

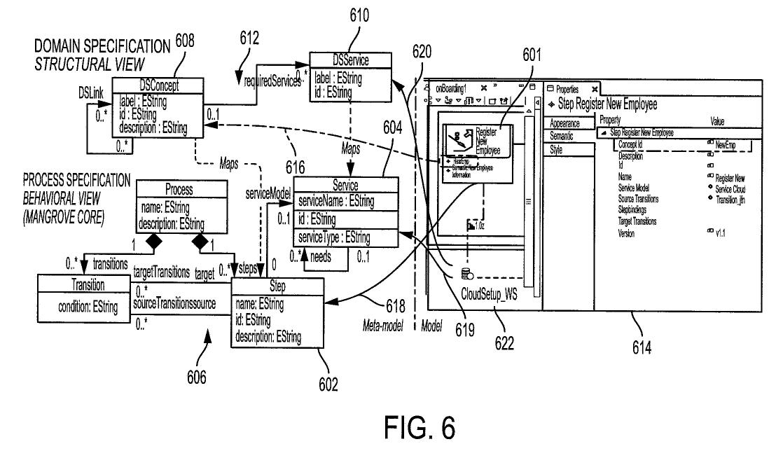

In FIG. 6, a few select elements relevant for describing the approach for a meta-model are depicted. In this example, the step 601 in the business process that is depicted is “Register New Employee.” Of course, this is but one example and other types of steps in various types of business process are contemplated. The matching is done through unique identifiers (UID) attached to a Step element 602 and to a Service element 604 in a generic process meta-model 606 and to a DS Concept 608 and a DS service 610 in a Domain MM 612. In this example, the unique identifier is “EString.” Of course, other unique identifiers could be used. It is also noted that in this example, the identifier “EString” is a class in the Eclipse EMF Framework. If Eclipse was not used, it would be something like the Java class “String,” for example.

The Domain MM 612 (of which a possible description is in FIG. 2) is only partially represented in FIG. 6. In fact, FIG. 6 is essentially an example to illustrate the overall mechanism, focusing on one single important aspect, i.e. the connection between the domain specification (or structural view) 612 (e.g., the DSConcept element 608 and the DSService element 610) with the process specification (or behavioral process view) 606 (e.g., the Step element 602 and the Service element 604).

The “Model” 614 on the right is just an example of how the meta-model elements on the left, represented by the domain specification 612 and the process specification 606, would be instantiated behind the scenes in a real scenario. In fact, the part on the right (model) is not compulsory, it is just used to explain the various functions. The Model 614 is in fact pointing to the instantiation of the above-mentioned meta-model elements in the diagram editor. Since these model-based techniques are used for generating the studio, the diagram editor is in fact based on models itself.

The domain specification 612 is the Domain MM. It is there to show that when processes are defined using the Studio, it is helpful to refer to elements of business know-how from the domain description. Therefore, it is helpful to connect the process description (or specification) to the actual elements of the domain, i.e., the DS concepts and DS services.

The arrows (616, 618, 619, 620) are used to point out conceptual matching between the example on the right and the actual underlying meta-models on the left. The first arrow 616 shows that Register New Employee 601 in the diagram 614 corresponds on one hand to a DS Concept 608 and on the other hand it is an actual process Step, as it is part of a Process (as shown by the second arrow 618). The third arrow 618 from CloudSetup_WS 622 is there to show that this diagram element actually corresponds to a Service element from the process. The fourth arrow 619 is pointing to DSService 610 as indeed it represents a domain specific service that is used in an actual process.

Since the diagram editor templates 70 are based on these meta-models, internal logic that bridges the two based on their UIDs ensures that the user operates within a given domain when designing processes. So a graphical diagram designed to contain generic process elements (the template) can be automatically made, at runtime, to display domain-specific icons and representations based on the Domain MM instance used for the GDPS 52.

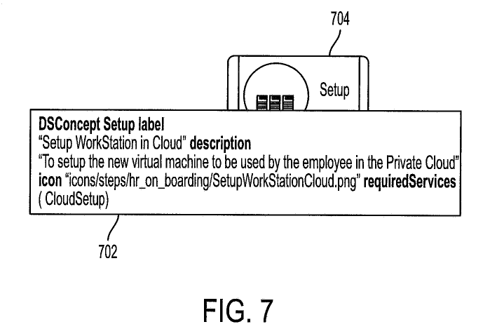

Thus, the diagram editor template 70 is essentially a model that attaches graphical representations to the elements of the two meta-models 606, 612 described above. For instance, they may specify that a Step is displayed as a rectangle with specific text in it and with an icon that matches the icon of the DS Concept element of the same UID. Such a graphical representation can be significantly enriched to show the connection to services or indeed a full textual representation of the domain fragment that corresponds to the concept, using a textual viewer 702 overlaid on the graphical concept element 704, as illustrated in FIG. 7.

Given the dynamic nature of UID-based mapping at runtime, with a proper distribution mechanism, the approach ensures that the user always has the latest version of the concept, including its visual representation, properties, SLAs and service dependencies. Similarly to the concept element display, several other graphical elements are described in the diagram templates, such as: transitions (shown as arrows of varying line types based on certain properties), services, SLAs and monitoring data shown as labels and decorators to various graphical elements.

B. Palette Template

Similarly to the diagram template 70, the palette template 72 is configured to contain the main functionality of a process design tool palette. It contains sections for standard functionality that are domain-independent as well as sections for domain-specific elements. For instance, typical domain-independent functionality includes dragging a business concept form the palette onto the graphical editor, launching a wizard to perform the selection of business concepts for a given task, connecting process activities using transition tools, connecting service dependencies to custom activity elements, among others. The domain-specific sections contain elements on the palette that are automatically injected in the palette at runtime, and updated each time the GDPS 52 is executed, to correspond to the latest version of the concept set in the Domain Description. So the palette template 72 contains the generic tools that do not depend on the domain as well as placeholders for domain-specific tool elements that will be injected in the GDPS palette at runtime. This ensures that the GDPS 52 is always updated to the latest version for constantly evolving business domains.

In contrast to the diagram template 70, the palette template 72 typically needs to go through an update each time a GDPS instance is launched. This requires a model-generation phase that needs to be completed before the GDPS 52 is fully launched. After the domain-specific part of the palette is generated, the palette template 72 is considered instantiated and needs to be injected into the runtime dependencies of the GDPS studio that is undergoing the launch procedure.

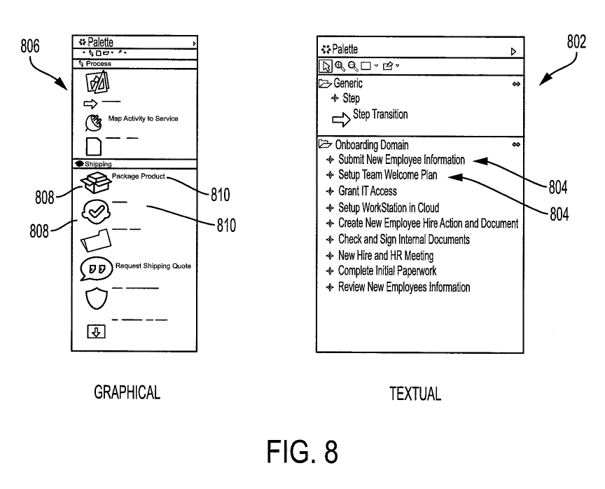

The two images in FIG. 8 show possible palette representations generated from similar templates. The first palette representation 802 is textual, showing just the names 804 of the injected concepts. The second palette representation 806 is graphical showing the icons 808 corresponding to the represented concepts 810. Both palette representations 802, 806 are easily generated for any domain by simply altering the palette template 72.

C. BPMN Generation

BPMN generation is part of the GDPS 52 and allows it to generate process artefacts that can be executed on state-of-the-art BPMS technology stacks through BPMN transformation templates 74. Similarly to the previous components, it has a basic implementation that corresponds to generic process descriptions. This takes as input an instance of the generic process meta-model and outputs a BPMN2 representation. However, it can be customized to add extra functionality for individual domains. This extra functionality can be provided as separate independent plugins that carry additional code that is invoked for certain DS Concept instances. There are several straightforward approaches to accomplish thus, such as the Eclipse extension mechanism1. Once BPMN generation is completed, technical users can use the embedded BPMN2 graphical editors to check, enhance and validate models before their deployment.

Herein lies a different challenge related to the management of change across various editors dealing with different aspects of the same process models. Various techniques based on model comparison, such as EMFCompare2, may help ensure that the process models are kept in sync.

D. Common Base Templates

Similar to BPMN generation, other standard BPM-related capabilities need to be offered by the GDPS in the form of common base templates 76. The common base templates 76 can be used in their original form or extended through additional extension mechanisms to perform additional tasks for specific domain concepts. Some of them are included here from a tooling perspective.

The main capabilities required, include, but are not limited to:
deployment of the domain-specific processes
SOA connectivity
domain-specific monitoring
collaborative process design

The deployment part detailed in concerns the transformation of design artefacts (diagrams+descriptions) into execution artefacts (deployment files on a runtime engine).

SOA connectivity refers to the relations between the business concepts in the domain description and the technical services in the technical infrastructure (the Service Oriented Architecture).

Domain-specific monitoring, detailed in brings combined information from the various execution platforms into the process representations in the GDPS.

Lastly, collaborative process design relates to the ability of groups of stakeholders to work simultaneously on various parts of process description without risk of conflicting changes. This can be very useful for instance in cases where a business analyst works with a customer and asks people from the team back at the office to add functionality to a process while still engaging with the customer on the process design. It can also prove useful when certain experts with specific knowledge in legal aspects of a domain need to check the compliance to certain regulations of particularly sensitive process fragments. They could correct the process design and trigger the locking up of the sensitive parts of the process until the conflicts are resolved.

The screenshot in FIG. 9 shows an example of a GDPS instance 902 for a sample domain in accordance with aspects of the exemplary embodiment. The top left part of the studio is a navigation map 904 for the diagram editor. The central part of the studio represents the diagram editor 906. On the right side there is the palette 908 showing both generic elements 910 in the upper half and domain-specific elements 912 in the bottom half. Note that while the screen shot shows only a small list of domain concepts in the palette 908, this could be significantly longer in a real-world scenario. Displaying large collections of element in a palette is not ergonomic so ways to manage such complexity would be employed including folding subsections, search-based filtering of elements and wizard-based selection of appropriate concepts. On the lower right part of the studio there are a number of views 914 including a property view that can display domain concept information. Note that such information can also be accessible with a built-in textual overlay editor as illustrated in FIG. 7. Finally on the lower left side of the studio there is a monitoring view 916 that displays aggregated monitoring data of the selected element in the diagram. As mentioned before, such monitoring information can also be displayed for other editors such as the BPMN Modeler.

The diagram editor 906 enables intuitive process design using elements from the palette 908. When business users select an element from the palette 908 they can add it to a process and take advantage of the predefined functionality that it brings. For instance, the service connections are automatically added to the diagram (and to the underlying model that would be used to generate BPMN and correlate monitoring data). In the screenshot, the Register New Employee concept displays a connection to a cloud setup service (which in turn displays a dependency to another service). It also shows monitoring data collected for the service execution on the service connection and for the concept execution as a decorator to the concept element. The concept activity elements also show in a diamond-shaped decorator the version number. This version corresponds to the version at the time of the addition of the concept to the process. The rule-based display of the version information specifies that a version shown in green corresponds to the latest version of the concept from the centralized domain repository (also matched by the latest version shown in the palette for each concept). A version shown in a specific color may signify that a newer version is available. Note that enterprise policy may dictate that automatic migration is enforced for all processes to use the latest version of the domain, or this could be simply notified to users who may choose a course of action. A migration scenario can occur when a particular concept (such as a verification task) becomes automated. This would be clearly visible in the new version by displaying a link to a service dependency and removing the need to generate a BPMN Manual Task and the corresponding form.

When the process design requires functionality that is not available in the list of concepts, the user would be offered an option to choose a Custom Activity from the generic part 910 of the palette. This would signify that the functionality needs to be developed and can indicate a possible evolution for the domain repository if such functionality needs to be reused in the future. The user can also choose to indicate a desired connection of the custom activity to existing services. This would inform the generation mechanism to take the service into account when generating the corresponding BPMN (by creating a matching BPMN Service Task, for instance).

The GDPS instance 902 also has a layering system that allows the display of various levels of complexity based on user interests and skills. For instance, the services part or the monitoring labels and decorators are grouped in transparent layers that can be activated and deactivated manually or automatically depending on the situation.

Several GDPS instances can be used concurrently by different users working on the same process models. In this regard, the two screenshot fragments 1002, 1004 in FIG. 10 represent portions of GDPS instances and show the same process fragment being edited concurrently by two users. In this example, in the first fragment 1002, User 1 proposed a flow where the Sign activity 1006 follows directly the Validate Paperwork activity 1008. In the second fragment 1004, User 2 decides that this does not comply with company policy and decides to remove the direct transition 1010 between the two tasks 1006, 1008 and add an additional task (HR Meeting) 1012 in between. A number of locks 1014 are displayed on the diagram of User 1 (1002) as this addition is done. The locks 1014 might appear in red, for example, on the display screen. Until User 2 does not save their changes, User 1 would not be able to operate on this process fragment (although they would be able to modify the rest of the diagram). On the other hand, a number of locks 1016 may be displayed on the diagram of User 2 (1004). The locks 1014 might appear in green, for example, on the display screen, since User 2 may make changes.

With properly managed central repository of domain descriptions, any organization can automatically generate and distribute domain-specific graphical process studios that are simple to use yet powerfully connected to state-of-the-art BPMS running BPMN descriptions. In addition to design, the studios can offer simple to understand monitoring integration and provide real-time collaborative design capabilities in distributed settings.

The generative, model-driven approach presented herein aims to improve the design activity of business process stakeholders across organizations while ensuring governance and centralized management of business processes. While the discussion herein focuses on generating the process design studios, the overall approach using domain-specific concepts at its core has much larger overall strategic advantages, such as improved governance and agility. The approach enables business experts to collaborate and use an intuitive non-ambiguous notation in their design activities that is explicitly defined in the shared domain description while allowing for technical details to beaded in the generated BPMN. The automatically generated studios combine standard and extended functionalities, depending on the domain and automatically evolve with the domain knowledge through continuous integration of the domain artefacts in the GDPS. Besides designing processes they give users with appropriate rights the ability to update any parts of the domain-description ensuring the domain knowledge grows organically. Lastly, the superposition of monitoring information on the appropriate graphical elements used in the process design, facilities the understanding of implications of business process design decisions. Combined with the separation of concerns between business concepts and their technical service counterparts, this can provide a useful mechanism for future process evolution as well as for more strategic decisions (if technical service always executes slowly for the same set of business concepts thus infringing their SLAs, the company can decide to switch for other services for those concepts and the change is done centrally at the domain-description level and propagated to all processes and all users automatically).

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A method of generating a domain specific process studio, the method comprising:
performing initialization and/or an update of a generated domain-specific process studio (GDPS);
combining a domain specification and a GDPS template;
displaying a freshly generated GDPS instance;
providing a way for a user to select a domain to work in via a user interface;
receiving data from the user regarding new diagrams that have been created and/or automatically loading existing saved diagrams that have been selected from one or more centralized repositories;
receiving data regarding collaboratively edited diagrams from one or more users;
receiving updates from monitoring infrastructure populating the process diagram and the various version numbers and other details being shown in the diagrams received.

2. The method of claim 1, wherein the domain specification comprises a domain meta-model and domain descriptions, the domain meta-model comprising domain information for an enterprise with regard to the specification of concepts that are going to be reused in business processes and the domain descriptions comprising knowledge of a business domain configured for reuse and combining business concepts in business processes.

3. The method of claim 2, wherein the domain meta-model is configured to: describe a data structure of arbitrary domain specifications, store domain information for each business domain in a central repository on a collaboration and distribution server, generate a domain editor that can be used standalone or embedded in a graphical editor as part of a diagram designer used in the GDPS, provide model matching when combining generic process elements with domain elements and/or specify and update Service Level Agreements for business concepts.

4. The method of claim 2, wherein the GDPS template comprises a diagram editor template and a palette template, the diagram editor template comprising a declarative model-based description of one or more capabilities that the GDPS offers to provide graphical process modelling and configured to match graphical elements to the domain meta-model and to a generic process representation and the palette template comprising the main functionality of a process design tool palette.

5. The method of claim 4, further comprising updating the palette template each time a GDPS instance is launched.

6. The method of claim 4, wherein the GDPS template further comprises one or more business process model and notation (BPMN) templates configured for BPMN generation and one or more common base templates.

7. A system for generating a domain specific process studio, the system comprising memory and at least one processor, wherein the system is configured to:
perform initialization and/or an update of a generated domain-specific process studio (GDPS);
combine a domain specification and a GDPS template;
display a freshly generated GDPS instance;
provide a way for a user to select a domain to work in via a user interface;
receive data from the user regarding new diagrams that have been created and/or automatically load existing saved diagrams that have been selected from one or more centralized repositories;
receive data regarding collaboratively edited diagrams from one or more users;
receive updates from monitoring infrastructure populating the process diagram and the various version numbers and other details being shown in the diagrams received.

8. The system of claim 7, wherein the domain specification comprises a domain meta-model and domain descriptions, the domain meta-model comprising domain information for an enterprise with regard to the specification of concepts that are going to be reused in business processes and the domain descriptions comprising knowledge of a business domain configured for reuse and combining business concepts in business processes.

9. The method of claim 8, wherein the domain meta-model is configured to: describe a data structure of arbitrary domain specifications, store domain information for each business domain in a central repository on a collaboration and distribution server, generate a domain editor that can be used standalone or embedded in a graphical editor as part of a diagram designer used in the GDPS, provide model matching when combining generic process elements with domain elements and/or specify and update Service Level Agreements for business concepts.

10. The method of claim 8, wherein the GDPS template comprises a diagram editor template and a palette template, the diagram editor template comprising a declarative model-based description of one or more capabilities that the GDPS offers to provide graphical process modelling and configured to match graphical elements to the domain meta-model and to a generic process representation and the palette template comprising the main functionality of a process design tool palette.

11. The method of claim 10, further comprising updating the palette template each time a GDPS instance is launched.

12. The method of claim 10, wherein the GDPS template further comprises one or more business process model and notation (BPMN) templates configured for BPMN generation and one or more common base templates.

13. A non-transitory computer-usable data carrier storing instructions that, when executed by a computer, cause the computer to perform a method of generating a domain-specific graphical process studio, the method comprising:
performing initialization and/or an update of a generated domain-specific process studio (GDPS);
combining a domain specification and a GDPS template;
displaying a freshly generated GDPS instance;
providing a way for a user to select a domain to work in via a user interface;
receiving data from the user regarding new diagrams that have been created and/or automatically loading existing saved diagrams that have been selected from one or more centralized repositories;
receiving data regarding collaboratively edited diagrams from one or more users;
receiving updates from monitoring infrastructure populating the process diagram and the various version numbers and other details being shown in the diagrams received.

14. The non-transitory computer-usable data carrier of claim 13, wherein the domain specification comprises a domain meta-model and domain descriptions, the domain meta-model comprising domain information for an enterprise with regard to the specification of concepts that are going to be reused in business processes and the domain descriptions comprising knowledge of a business domain configured for reuse and combining business concepts in business processes.

15. The non-transitory computer-usable data carrier of claim 13, wherein the domain meta-model is configured to: describe a data structure of arbitrary domain specifications, store domain information for each business domain in a central repository on a collaboration and distribution server, generate a domain editor that can be used standalone or embedded in a graphical editor as part of a diagram designer used in the GDPS, provide model matching when combining generic process elements with domain elements and/or specify and update Service Level Agreements for business concepts.

16. The non-transitory computer-usable data carrier of claim 13, wherein the GDPS template comprises a diagram editor template and a palette template, the diagram editor template comprising a declarative model-based description of one or more capabilities that the GDPS offers to provide graphical process modelling and configured to match graphical elements to the domain meta-model and to a generic process representation and the palette template comprising the main functionality of a process design tool palette.

17. The non-transitory computer-usable data carrier of claim 16, further comprising updating the palette template each time a GDPS instance is launched.

18. The non-transitory computer-usable data carrier of claim 16, wherein the GDPS template further comprises one or more business process model and notation (BPMN) templates configured for BPMN generation and one or more common base templates.
